(19) United States
(12) Patent Application Publication
(10) Pub. No.: US 2014/0179890 A1
(43) Pub. Date: Jun. 26, 2014

(54) USE OF EPOXIDISED ARYL ALKYL PHENOLS AS REACTIVE RESIN DILUENTS

(71) Applicants: Bodo Friedrich, Duisburg (DE); knut Hillner, Selm (DE); Rolf Herzog, Beethovenstrabe 12a (DE); Peter Mühlenbrock, Dusseldori (DE); Manuela Grewing, Roderichstrabe 50 (DE); Dirk Sichelschmidt, Duisburg (DE); Manuela Grewing, Moers (DE)

(72) Inventors: Bodo Friedrich, Duisburg (DE); knut Hillner, Selm (DE); Rolf Herzog, Beethovenstrabe 12a (DE); Peter Mühlenbrock, Dusseldori (DE); Manuela Grewing, Roderichstrabe 50 (DE); Dirk Sichelschmidt, Duisburg (DE); Manuela Grewing, Moers (DE)

(73) Assignees: Momentive Specialty Chemicals GmbH, Iserlohn-Letmathe (DE); Rutgers Germany GmbH, Castrop-Rauxel (DE)

(21) Appl. No.: 14/007,212

(22) PCT Filed: Mar. 7, 2012
(86) PCT No.: PCT/EP2012/053890

§ 371 Date: Dec. 9, 2013

(30) Foreign Application Priority Data
Mar. 25, 2011 (DE) 10 2011 015 193.1

(51) Int. Cl. C08G 59/62

(52) U.S. Cl. CPC C08G 59/621
USPC 528/103; 252/183.11

(57) ABSTRACT

Glycidylated mono(alkyl aryl)phenols (styrenated phenols) or mixtures thereof are suitable for use as reactive diluents and co-reactants in the production of epoxy resins and have the structure of the general formula I shown hereinbelow

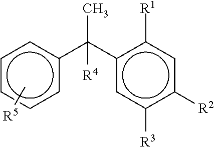

wherein R¹ and R² independently of one another denote —H, C₁₋₃-alkyl, C₁₋₃-oxalkyl and glycidyl, but R¹ and R² are not simultaneously glycidyl, R³ is an optionally substituted styryl of the formula

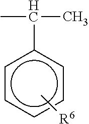

R⁴ is a hydrogen residue or methyl, and R⁵ and R⁶ are in each case a hydrogen residue, C₁₋₃-alkyl, C₁₋₂-oxalkyl.

### FIELD OF THE INVENTION

The invention relates to the use of glycidylated mono(alkyl aryl)phenols as reactive diluents for epoxy resins compositions, polymerisable compositions containing these, and their use in epoxy resins.

### BACKGROUND OF THE INVENTION

Glycidylated (epoxydised) compounds are used in various compositions for a very wide range of applications. Depending on their composition they are used for example as composite materials, electro laminates, adhesives, lacquers, electro casting resins or also in the building and construction sector.

In order that the desired processing properties can be achieved, the individual constituents of the compositions must be matched to one another. Thus, a composition that is specified for the aforementioned uses contains as a rule one or more epoxy resin components (thus, based on bisphenol A and F, cycloaliphatic resins, brominated resins, phenol novolak resins), curing agents (such as base amines, adduct curing agents, Mannich base curing agents, polyaminoamide and polyaminoimidazole curing agents), accelerators (such as benzyldimethylamine and 2,4,6-tri (N,N-dimethylaminomethyl)phenol) and fillers.

In order to improve mechanical properties and for reasons of cost it is often desirable to increase the proportion of inorganic fillers. However, too high a proportion of non-reactive fillers leads to difficulties in the processing, starting with the production of the composition in situ up to the use for example as a coating.

It is known to add benzyl alcohol or high-boiling point solvents such as styrenated phenol(mono(alkyl aryl)phenol) in order to reduce the mixing viscosity of the composition. Styrenated phenol can be added in order to improve the flow, to accelerate the curing reaction and to achieve better surface properties, for example in coating systems. A disadvantage of the use of styrenated phenols are increased VOC values and/or reduced mechanical properties of the cured epoxy resin.

Furthermore it is known to add monofunctional or multifunctional reactive diluents as viscosity-reducing constituents. A reactive diluent serves to adjust the viscosity of the mixture and during the curing process is chemically bound in the cured composition, so that the emission of solvents can as a rule be reduced.

Various reactive diluents are known for the production of epoxy resins. These include low-viscosity monofunctional, difunctional or polyfunctional epoxides or epoxy resins based on monohydric fatty alcohols, dihydric alcohols or polyhydric alcohols. A disadvantage of the use of monofunctional reactive diluents based on aliphatic compounds such as C₁₂-C₁₄ fatty alcohols is a significant delay of the curing reaction (lower reactivity) compared to a system not containing reactive diluent. In addition aliphatic reactive diluents have a higher vapour pressure compared to the base resins, which can lead to restrictions during the processing.

It is also known to use epoxy compounds based on phenolic compounds as reactive diluents. Such phenolic compounds include phenol, cresol, bisphenol A or p-tert.-butylphenol. These have a significantly higher reactivity than epoxy compounds based on aliphatic alcohols. They also impart a high chemical resistance to the cured product, but are undesirable on account of their toxicological properties.

CH 324 686 describes the conversion of phenol with styrene and the reaction of the resultant product with a glycidyl ether in alkaline medium to form a non-meltable product.

### SUMMARY OF THE INVENTION

The object of the invention is to provide reactive diluents with a high reactivity for epoxy resin compositions, which do not have the disadvantages specified hereinbefore.

This object is achieved by using one or more compound(s) of the general formula I

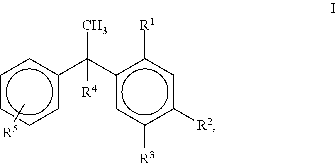

wherein R¹ and R² independently of one another denote —H, C₁₋₃-alkyl, C₁₋₃-oxalkyl and glycidyl, but R¹ and R² are not simultaneously glycidyl, R³ is an optionally substituted styryl of the formula

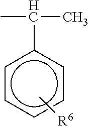

where R⁴ is a hydrogen residue or methyl,
R⁵ and R⁶ are a hydrogen residue, C₁₋₃-alkyl, C₁₋₂-oxalkyl,
as reactive diluents in epoxy resin compositions.

C₁₋₃-alkyl includes methyl, ethyl, propyl and isopropyl. C₁₋₃-oxalkyl includes methoxy, ethoxy, propoxy and isopropoxy.

The subject matter of the invention is also the use of a mixture of epoxidised mono(alkyl aryl)phenols, i.e. styrenated phenols with a glycidyl radical, as reactive diluents for epoxy resin compositions.

This mixture contains a plurality of compounds of the chemical formulae 1a, Ib and Ic shown hereinafter:

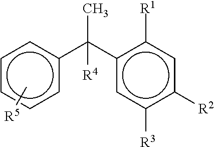

wherein

in the compound Ia R¹ denotes

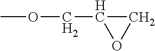

R², R³: H
   and
   in the compound Ib R¹, R³: H

R²:

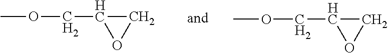

and in the compound Ic R¹
R²:H
R³:

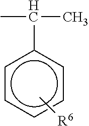

and R⁴, R⁵ and R⁶ have the meanings given above.

Another object of the invention is a composition with one of the aforementioned compounds or a mixture of these compounds, which contains at least one cross-linkable polymer.

Surprisingly a composition of one or more epoxy compounds according to the invention as reactive diluent exhibits a comparable reactivity compared to conventional aromatic diluents such as phenol, cresol or p-tert.-butylphenol, despite having a high steric hindrance. The reactivity of the reactive diluents according to the invention is higher than that of aliphatic reactive diluents based on monohydric or dihydric alcohols.

### DESCRIPTION OF PREFERRED EMBODIMENTS

Preferably the mixture to be used according to the invention as reactive diluent basically contains the following compounds:

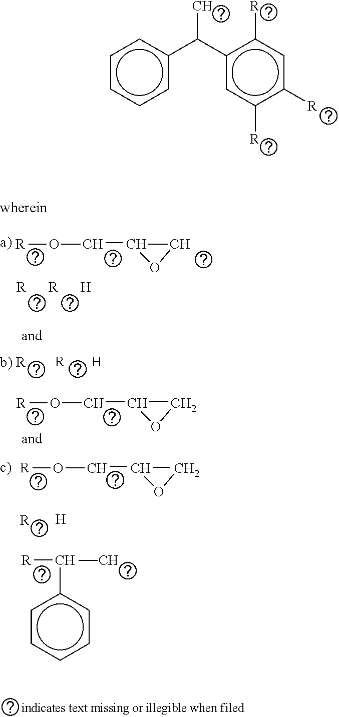

These compounds can be contained in an amount of at least 60 wt. %, preferably at least 80 wt. %, particularly preferably at least 90 wt. % or at least 95 wt. % in the mixture to be used according to the invention.

Preferably a mixture contains, referred to the sum of the masses of the compounds of the formulae Ia, Ib and Ic, 30 to 60 wt. % of Ia, 10 to 25 wt. % of Ib and 20 to 40 wt. % of Ic.

The mixture used according to the invention can be obtained by epoxidation of styrenated phenol. The production of styrenated phenol by reaction of a phenolic component with an olefin is known and is described for example in EP 0 656 384 A2. These are essentially alkylation reactions, in which the vinyl group of the styrenes adds in the ortho- or para-position to the hydroxyl group of the phenol. In general Friedel-Crafts catalysts, for example acids and Lewis acids, are used in this reaction. The addition of the vinyl compound to phenols can take place in a molar ratio of the phenolic hydroxyl group in the phenol to the aromatic compound of 1:1 to 1:2.

Suitable aromatic vinyl compounds are in particular alpha-methyl styrene, styrene, o-methylstyrene, m-methylstyrene, p-methylstyrene, commercially available vinyltoluene (isomeric mixture), 3,4-dimethylstyrene, 2,4-dimethylstyrene, 2,5-dimethylstyrene, 2,6-dimethylstyrene, o-ethylstyrene, m-ethylstyrene, p-ethylstyrene, 3,4-diethylstyrene, 2,4-diethylstyrene, 2,5-diethylstyrene and 2,6-diethylstyrene.

Mixtures of styrenated phenols are marketed for example by RUTGERS Novares GmbH under the trade name “Novares”.

The cationically induced conversion of styrenated phenol results in a statistical distribution of 2-, 4- and 2,4-substituted phenols. In order to obtain the individual styrenated compounds the monostyrenated compounds can first of all be separated from the distyrenated phenol by vacuum distillation. The mixture of the monostyrenated compounds can then be separated by crystallisation into the 2-styrenated and the 4-styrenated phenol.

The styrenated phenol or a mixture of styrenated phenols is reacted with an oxirane compound to obtain the epoxidised compounds according to the invention. In this connection the phenolic OH group reacts with the oxirane compound. Epichlorohydrin is preferably used as oxirane compound. The reaction is generally carried out in the presence of an alkali hydroxide, for example sodium hydroxide, at elevated temperature according to the theoretical equation with elimination of sodium chloride and water to give the glycidyl compound of the invention according to the following reaction scheme:

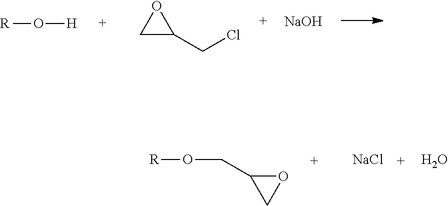

This reaction is in principle known, wherein R is the common building block of the substances 1a, Ib and Ic and the benzene ring has an OH group at the corresponding positions.

Surprisingly the mixture used according to the invention can be employed as reactive compound even if a hydrophobising action is to be achieved. This can take place for example in coating compositions by using the mixture according to the invention as resin constituent or as reactive diluent with at least one further resin constituent. Also, the mixture can be used as a modifying agent in the polyester synthesis, for example in order to reduce acidic groups or alcohol groups, with a simultaneous increase in hydrophobicity. Furthermore the mixture according to the invention can be used as a paper treatment agent, without exhibiting the known disadvantages of migration as in the case of non-reactive phenolic components.

Surprisingly it was also found that when employing the mixture to be used according to the invention the resistance of composite materials, such as are increasingly used in producing wind energy, to water or aqueous media is improved.

In general this mixture can be used to produce reinforced or non-reinforced plastics (e.g. thermosetting materials, thermoplastics) and elastomers.

Particularly preferred are compositions that comprise as further component at least one cross-linkable plastic (thermoplastic, elastomer), in particular thermosetting plastic (such as polyester resin, epoxy resin, phenolic resin or melamine resin).

It is advantageous if the mixture according to the invention is present with at least one cross-linkable plastic in a ratio of 5:95 to 50:50. The production of the composition is carried out in the conventional way.

It is particularly preferred if the mixture to be used according to the invention contains as further component at least
d) an epoxy resin selected from glycidyl ethers based on bisphenol A, bisphenol F or novolaks, monohydric, dihydric or polyhydric alcohols, mono- or polyfunctional phenols such as phenol, cresol, resorcinols, naphthols, p-tert.-butylphenols, nonylphenols, cashew nut oil compounds, C₁₂-C₁₄-alcohols, butanediols and/or hexanediols
e) a curing agent selected from amine or acidic compounds as well as those curing agents that can initiate a homopolymerisation of epoxy compounds; and
f) optionally further additives, such as processing aids and inorganic fillers, preferably in an amount of 5 to 20 parts by weight referred to all components of the composition.

The use of glycidyl ethers based on bisphenol A, bisphenol F or novolaks, monohydric, dihydric or polyhydric alcohols, monofunctional or polyfunctional phenols such as phenol, cresol, resorcinols, naphthols, p-tert.-butylphenols, nonylphenols, cashew nut oil compounds, Ci₂-Ci₄-alcohols, butanediol and/or hexanediol as further component has the advantage that the composition does not crystallise and can be stored. The viscosity of this composition according to the invention can also be adjusted in a suitable range depending on the intended application.

Conventional curing agents for epoxides can be used. Typical examples of amine-type curing agents are compounds with one, two or more free amine hydrogen atoms. These can be provided via cyclic, aliphatic or aromatic couplings or via polyether groups. Typical members of this class of curing agents are amines such as isophorone diamine, xylylene diamine, trimethylene hexamethylene diamine, and polyether amines. Further suitable curing agents in the context of the invention are so-called acidic curing agents based on organic acids such as phthalic anhydride, hexahydrophthalic anhydride, methylhydrophthalic anhydride and also further compounds of this class. Latent systems are also not excluded, which are used via a radiation curing and an associated ionic curing or by thermal curing (“latent 1-component system”). Preferred in the context of the invention are amine-type curing agents for curing at room temperature, here in particular so-called adduct curing agents based on bisphenol A diglycidyl ether and isophorone diamine, which can be further modified by the use of benzyl alcohol, accelerators, as well as further additives in order to improve the processing properties or end uses. The mixing ratio with the epoxide-reactive components is obtained from the stoichiometric conversion. The exact mixing ratio is governed according to the use and can include a sub-stoichiometric as well as a hyper-stoichiometric conversion.

The epoxide composition according to the invention is prepared by mixing the individual components according to known methods

The mixing and filling process can be accelerated by mixing the components at elevated temperature, for example at 60° to 80° C.

Preferably the epoxy resin component d) is in a ratio of 95:5 to 50:50, particularly preferably 95:5 to 85:20, with respect to the sum of the components a) to c). In this range excellent mechanical properties are achieved in the cured state. Higher or lower proportions can also be used depending on the intended application.

The mixture according to the invention can be used to produce heat-curable products. Coatings or also moulded articles are therefore conceivable. It is particularly preferred if the mixture according to the invention is used for coatings, in particular for self-leveling coatings. Thus, coatings for industrial floor coverings, lacquers, adhesives or electro laminates would be feasible. The use according to the invention thus preferably applies to the treatment of paper, to producing cured polymer products, to forming coatings, and to producing reinforced and non-reinforced plastics, elastomers and moulded articles.

The following examples serve to further illustrate the invention.

### EXAMPLES

### Example 1

### Production of the Mixture to be Used According to the Invention

925 g epichlorohydrin (10 moles) are added to a 2 l capacity laboratory reactor with a discharge tap. The temperature is raised to 65° C. 466 g (2 moles OH) Novares® LS 500 (RUTGERS Novares GmbH) (styrenated phenol) as well as 29.3 g (0.1 mole) sodium hydroxide solution (20%) are then added. After the end of the dissolution procedure the temperature is raised to 100° C. The reaction mixture is stirred for 3 hours and then cooled to 45° C.

50 g isopropanol and 140 g water are now added to the reaction mixture. 400 g of 20% sodium hydroxide solution (stoichiometric amount) are metered in within 120 minutes. The temperature is held constant at 45° C. for 2 hours (2 hours post-reaction).

36 g NaCl are added and the mixture is allowed to react for a further 60 minutes. The temperature is then raised to 60° C.

The stirrer is switched off and after a settling time of 30 minutes the lower aqueous phase is discharged. The organic phase remaining in the reaction vessel is diluted with a further 200 g epichlorohydrin and washed with 300 g water, as a result of which a phase reversal occurs.

The organic phase is then distilled off in vacua up to a temperature of 120° C. and is freed from traces of volatile substances by steam distillation in vacua.

The distillate contains epichlorohydrin, isopropanol, water and higher boiling impurities in a concentration of less than 1% and can be used for a subsequent production.

The distillation residue is taken up in 248 g toluene, heated to 75° C., and 50% sodium hydroxide solution (MV 1:2.5—hydrolysable chlorine:sodium hydroxide solution) is added within 30 minutes. Prior to this the same amount of water is added. The reaction time while stifling is then 1 hour.

330 g toluene are added for the dilution. The stirrer is switched off and after a settling time of 10 minutes the aqueous phase is separated. The organic solution is washed repeatedly with water until neutral.

The toluene and remaining traces of volatile constituents are distilled off in vacua up to 125° C. The epoxy compound obtained as distillation residue is freed via a pressure filter from organic and inorganic solid accompanying substances. The yield is 95% referred to the initial stage.

Analysis results of the epoxy compound:

| Epoxy equivalent | 384 g/equiv. |
|---|---|
| Viscosity 25° C. | 545 mPas |
| Content of hydrolysable chlorine | 0.36% |
| Gardner colour | 9 |

### Example 2

### Use of the Mixture

The glycidated “styrenated phenol” (B) obtained in Example 1 is used to produce epoxy resin mixtures. For this purpose the bisphenol A diglycidyl ether is placed in a mixing vessel and the styrenated product (A) or the product (B) according to the invention is metered in while stirring. The temperature is kept between 65° C. and 70° C. during the stirring process. The curing agent is added in the specified concentration (Table 1) to this composition, if necessary after storage.

Using a floor coating (undercoat or as a self-leveling floor coating) the properties of compositions containing the product (A) (styrenated phenol) are compared with compositions containing the product (B) according to the invention.

TABLE 1

| | | II |
|---|---|---|
| Formulation constituents | I | (Invention) |
| Resin: | | |
| Bisphenol A diglycidyl ether EPIKOTE ® Resin 828LVEL | 80 | 80 |
| Styrenated phenol (A): | 20 | — |
| Styrenated phenol, glycidated (B): | — | 20 |
| Epoxy equivalent | 232 | 202 |
| Curing agent: | | |
| EPIKURE ® Curing Agent 551 (Adduct curing agent of bisphenol A | | |
| diglycidyl ether and isophorone diamine, modified inter alia with | | |
| benzyl alcohol) | | |
| Amine equivalent | 93 | 93 |
| Resin: Curing agent (parts by weight) | 100:40 | 100:46 |
| Properties: | | |
| Relative evaporation loss [curing for 96 hrs at 23° C., determination | 0 | −31% |
| of the evaporation loss by weight measurement 1 hour after application | | |
| and after storage (2 hours, 100° C., layer thickness 200 um) ] | | |

In order to determine the evaporation loss the coating composition is applied with a doctor blade to a glass plate in a layer thickness of 200 um. After one hour the glass plate is weighed. The glass plate is then stored for 96 hours at room temperature and then for 2 hours at 100° C. in a drying cabinet. The weight is then determined and the relative weight loss is calculated from the difference of the two weight measurements.

It was shown that the proportion of the volatile compounds during the curing is drastically reduced according to the invention, since the mixture II according to the invention is incorporated into the organic matrix, which is demonstrated by determining the evaporation loss.

In addition an improvement of the property profile in self-leveling coatings was observed (Table 2). The compositions were prepared as already described:

TABLE 2

| | | | II | |
|---|---|---|---|---|
| Formulation constituents | Reference: | I | Invention | III |
| Resin: | | | | |
| Bisphenol A diglycidyl ether EPIKOTE ® Resin | 100 | 90 | 90 | 90 |
| 828LVEL | | | | |
| C₁₂-C₁₄-glycidyl ether: | — | 10 | — | — |
| Styrenated phenol, glycidated (B): | | | 10 | |
| Hexanediol diglycidyl ether | | | | 10 |
| Epoxide equivalent [g/equiv.) | 186 | 193 | 194 | 180 |
| Viscosity [25° C., Pas] | 10.6 | 1.6 | 6.6 | 2.3 |
| Curing agent: | | | | |
| Adduct curing agent based on bisphenol A | | | | |
| diglycidyl ether and isophorone diamine | | | | |
| modified with benzyl alcohol and accelerator | | | | |
| EPIKURE ® Curing Agent F205 | | | | |
| Amine equivalent | 105 | 105 | 105 | 105 |
| Resin: curing agent [parts by weight] | 100:56 | 100:54 | 100:54 | 100:58 |
| Properties: | | | | |
| Pot life [100 g, time to Tmax, min], DIN 16945 | 39 | 44 | 43 | 37 |
| Gel time [23° C., min], DIN 16945 | 103 | 166 | 133 | 156 |
| Early water resistance 10° C. [4/8/24/48 hours], | −/−/0/0 | −/−/−/0 | 0/0/+/+ | −/0/0/+ |
| ISO 2812-4 | | | | |
| Early water resistance 23° C. [4/8/24/48 hours], | −/0/0/0 | −/0/0/+ | 0/+/+++/+ | 0/+/+/+ |
| ISO 2812-4 | | | | |
| Surface 10° C. [48 hours] visual DIN 53230 | Matt | Matt | Low matt | Matt |
| Surface 23° C. [48 hours] visual DIN 53230 | Good | Good | Glossy | Good |

By using the mixture II according to the invention (styrenated phenol, glycidated (B)) a significant acceleration of the curing action is found in direct comparison with the aliphatic reactive diluents (III). At the same time the early water resistance (resistance to undesirable side effects due to water during the curing, e.g. carbamate formation)—measured by comparison with the reference—is significantly improved.

The improvement of the mechanical properties is shown in Table 3.

TABLE 3

| | | II |
|---|---|---|
| Formulation constituents | I | (Invention) |
| Resin | | |
| Bisphenol A diglycidyl ether EPIKOTE ® Resin | 85 | 85 |
| 828LVEL | | |
| Neodecanoic acid glycidyl ether | 15 | — |
| Styrenated phenol, glycidated (B). | — | 15 |
| Resin: | | |
| Epoxide equivalent | 193 | 198 |
| Viscosity [25° C., Pas] | 1.5 | 5.6 |
| Curing agent: | | |
| Adduct curing agent based on bisphenol A | 54 | 53 |
| diglycidyl ether and isophorone diamine modified | | |
| with benzyl alcohol and accelerator EPIKURE ® | | |
| Curing Agent F205 (Amine equivalent 105 | | |
| g/equiv.) | | |

TABLE 4

| | | II |
|---|---|---|
| Initial values: | I | (Invention) |
| Mechanical properties | | |
| [curing for 7 days at 23° C.] | | |
| Shore D hardness, DIN EN ISO 868 | 79 | 83 |
| Bending strength [MPa], | 69 | 93 |
| DIN EN ISO 178 | | |
| E modulus [MPa], DIN EN ISO 178 | 1900 | 2700 |
| Tensile strength [MPa] DIN EN ISO | 45 | 62 |
| 527 | | |
| Elongation [MPa] DIN EN ISO 527 | 3.1 | 2.7 |
| Compression strength [MPa] | 67 | 87 |
| DIN EN ISO 604 | | |
| Tg [° C., DSC], IEC 1006 | 42 | 46 |
| Tg [° C., DMA], IEC 1006 | 58 | 60 |

DSC: Dynamic differential calorimetry
DMA: Dynamic mechanical analysis

Although monofunctional reactive diluents are involved in both cases, higher mechanical values are achieved when using (B).

The test for chemical resistance shows first of all that the measured Shore D values (hardness) when using monofunctional reactive diluents are comparable. However, when using (B) it takes twice as long until mechanical destruction occurs (4 weeks instead of 2 weeks) (Table 5).

TABLE 5

| | | II |
|---|---|---|
| Property: | I | (Invention) |
| Shore D hardness, initial value: | 83 | 83 |
| Shore D hardness after 4 weeks storage in: | | |
| Acetic acid | 78 (94) | 73 (88) |
| Petroleum spirit | 52 (63) | 50 (60) |
| Aromatic compounds | 68 (82) | 72 (87) |
| Water | 81 (98) | 81 (98) |
| Alcohol | 42 (51) | 64 (77) |
| Ester/ketone | Destroyed | Destroyed |
| | (2 weeks) | (4 weeks) |

Values in brackets: % of initial value (7 days at 23° C.)

1. A method of using a compound of formula I 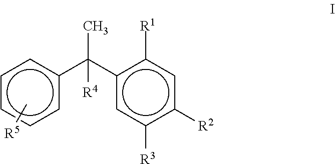
wherein R¹ and R² independently of one another denote —H, C₁₋₂-alkyl, C₁₋₂-oxalkyl and glycidyl, but R¹ and R² are not simultaneously glycidyl, R³ is an optionally substituted styryl of the formula 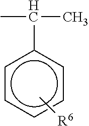
R⁴ is hydrogen or methyl, R⁵ and R⁶ independently from one another are hydrogen, C₁₋₃-alkyl, or C₁₋₃-oxalkyl, or
a mixture of glycidylated mono(alkyl aryl)phenols containing compounds of formula I,
as reactive diluents for epoxy resin compositions.

2. The method of claim 1,
wherein R¹ is 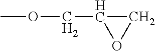
and
R² and R³ are hydrogen defined as compound of formula Ia.

3. The method of claim 1,
wherein R² is 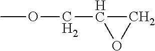
and
R¹ and R³ are hydrogen defined as compound of formula Ib.

4. The method of claim 1,
wherein R¹ is 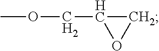
R² is hydrogen and R³ is a radical of the formula 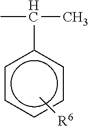
defined as compound of formula Ic.

5. The method of claim 1, wherein the mixture of compounds of formula I comprises compounds of formula Ia, Ib, and Ic.

6. The method of claim 5, wherein said mixture contains 30 to 60 wt. % of the compound of the formula Ia, 10 to 25 wt. % of the compound of the formula Ib and 20 to 40 wt. % of the compound of the formula Ic.

7. The method of claim 1 for treating paper, for producing cured polymer products, for producing coatings, for producing reinforced and non-reinforced plastics, elastomers and moulded articles.

8. A compound of the formula I or a mixture of compounds of the formula I and at least one cross-linkable polymer;
wherein formula I is 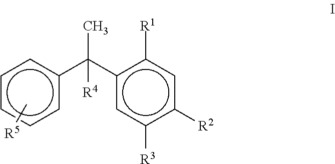
wherein R¹ and R² independently of one another denote —H, C₁₋₂-alkyl, C₁₋₂-oxalkyl and glycidyl, but R¹ and R² are not simultaneously glycidyl, R³ is an optionally substituted styryl of the formula 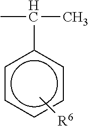
R⁴ is hydrogen or methyl, R⁵ and R⁶ independently from one another are hydrogen, C₁₋₃-alkyl, or C₁₋₃-oxalkyl, or
a mixture of glycidylated mono(alkyl aryl)phenols containing compounds of the general formula I.

9. A compound or mixture of compounds of claim 8, wherein the mass ratio of a compound of claims 1 to 4 or a mixture of claims 5 to 7 and a cross-linkable polymer is 95:5 to 50:50, in particular 95:5 to 85:15.

10. A compound or mixture of compounds of claim 8 wherein said cross-linkable polymer comprises:
a) an epoxy resin selected from alcoholic compounds that are able to form glycide compounds, in particular glycidyl ethers based on bisphenol A, bisphenol F or novolaks, monohydric, dihydric or polyhydric alcohols, monofunctional or polyfunctional phenols such as phenol, cresol, resorcinols, naphthols, p-tert.-butylphenols, nonylphenols, cashew nut oil compounds, C₁₂-C₁₄ alcohols, butane-diols, hexanediols and
b) a curing agent selected from amine-type or acidic compounds as well as those curing agents that are able to initiate a homopolymerisation of epoxide compounds, and
c) optionally further additives.
